(19) United States
(12) Patent Application Publication
(10) Pub. No.: US 2010/0134410 A1
(43) Pub. Date: Jun. 3, 2010

(54) IMAGE DISPLAY DEVICE

(76) Inventor: Isao Tomisawa, SAITAMA (JP)

Correspondence Address: YOUNG & THOMPSON, 209 Madison Street, Suite 500, Alexandria, VA, 22314, US

(21) Appl. No.: 12/443,594

(22) PCT Filed: Oct. 2, 2006
(86) PCT No.: PCT/JP2006/319707

§ 371 Date: Apr. 8, 2009

(51) Int. Cl. G09G 3/00; G09G 5/00

(52) U.S. Cl. 345/156; 345/32

(57) ABSTRACT

An image display device easily displays a stereoscopically two-dimensional image and improves its direction effect and interactivity. A display device is included of a display element for displaying an image on a screen, an image transmission element that is set in a light path for a display light component of the image and that transmits the display light component of the image so that a real image of the image is displayed on an image forming surface positioned at a space on a side opposite to the screen as a stray image. The display device includes a property specifying element for specifying a property of a detected object positioned in a real space portion including the space where the stray image is displayed and a control element for controlling the display element so the stray image changes into a form corresponding to the specified property of the object in advance.

### TECHNICAL FIELD

The present invention relates to an image display apparatus for stereoscopically displaying a two-dimensional image on the basis of a 3D (Dimension) floating vision method, for example.

### BACKGROUND ART

This type of stereoscopic two-dimensional image can improve a realistic sensation, visibility, amusement, and the like in interior decorations, promotion displays, communication terminal apparatuses, game equipment, and the like. Hence, various methods for displaying the stereoscopic two-dimensional image have been suggested. For example, a polarization method is suggested in which a viewer wears polarized glasses and views right and left parallax images based on mutually different polarization states. However, this method may cause such a problem that it is bothersome for the viewer to wear the polarized glasses.

In order to deal with the problem, for example, a lenticular lens method has been suggested as a stereoscopic image display method which does not use the polarized glasses (e.g. refer to a patent document 1). According to this method, a plurality of screens are hidden in one screen, and the plurality of screens are shown through a transmissive screen, obtained by connecting semicircular-column-type lenses of a certain width in a horizontal direction, to thereby realize stereoscopic representation and motion-picture representation.

Alternatively, the 3D floating vision method has been suggested by the present inventors. According to this method, by providing a two-dimensional image as a real image by a microlens array, it is possible to display a stereoscopic two-dimensional image in a relatively simple structure. In particular, in order to realize an interactive apparatus in this method, a technology has been suggested that uses a position detection sensor to change a stereoscopic two-dimensional image displayed on an image formation surface in accordance with an output signal from the position detection sensor (e.g. refer to a patent document 2).
Patent Document 1: Japanese Patent Application Laid Open No. Hei 10-221644
Patent Document 2: Japanese Patent Application Laid Open No. 2005-141102

### DISCLOSURE OF INVENTION

### Subject to be Solved by the Invention

However, for example, in the technology disclosed in the patent document 1, there is the following problem in terms of cost; namely, in the aforementioned lenticular lens method, the plurality of screens are hidden in one screen, and therefore, it requires the parallax images corresponding to the both eyes of the viewer from the imaging stage. Moreover, in order to supply the images, many operations are required: for example, computer image processing, lenticular lens designing, and an operation of accurately combining the lenses and the images. This causes high cost.

Alternatively, according to the technology disclosed in the aforementioned patent document 2, the problem in cost associated with the patent document 1 can be solved and a certain degree of rendering effect and interactivity are ensured; however, there is still room for improvement in the rendering effect and interactivity. For example, a toy gun, a knife, a fork, a dryer, a brush, and the like have mutually different attributes (shapes, applications, functions, or the like) in reality; however, if only the same reaction is provided regardless of which tool to be used to operate the image display apparatus, it is not interesting and it is hardly said that the rendering effect and interactivity are sufficient.

In view of the aforementioned problems, it is therefore an object of the present invention to provide an image display apparatus which displays a stereoscopic two-dimensional image, relatively easily, and which can improve the rendering effect and interactivity.

### Means for Solving the Subject

The above object of the present invention can be achieved by an image display apparatus provided with: a displaying device for displaying an image on a screen; an image transmitting device which is disposed on an optical path of display light which constitutes the image and which transmits the display light which constitutes the image so as to display a real image of the image as a floating image on an image formation surface located in a space on an opposite side to the screen; an attribute specifying device for specifying an attribute of a detected object located in a real space portion including the space; and a controlling device for controlling the displaying device to change the floating image into a form which is associated with the specified attribute of the detected object in advance.

According to the present invention, as described later, it is possible to display the stereoscopic two-dimensional image, relatively easily, and it is also possible to improve the rendering effect and interactivity.

In other words, firstly, the image is displayed on the screen by the displaying device such as a color liquid crystal display apparatus.

Here, the image transmitting device including e.g. a microlens array is disposed on the optical path of the display light which constitutes the image. By this image transmitting device, the display light which constitutes the image is transmitted and displayed as the floating image on the image formation surface in which the real image is located in the space on the opposite side to the screen. The “floating image” herein is an image which looks as if it were floating in the air from a user located at the observation position (i.e. in the range of user's view angle), and it is preferably the real image. For example, it includes such an image display method as a 3D floating vision (registered trade mark of the present inventors) method or an integral photography method.

By the way, even if an operation is performed on the floating image as displayed above with a tool, such as a toy gun, a knife, a fork, a dryer, and a brush, if only the same reaction is provided, it is not interesting and it is hardly said that the rendering effect and interactivity are sufficient.

According the present invention, however, the attribute of the detected object located in the real space portion including the aforementioned space is specified by the attribute specifying device. The “detected object” herein is typically an instrumental object having some attribute, and it includes a toy gun or a fork, for example. The “attribute” of the detected object is a unique property or characteristic provided for the detected object itself, and it conceptually includes a shape, a function, a concept, and the like. The attribute of the detected object is specified by being detected by the attribute detecting device, which is one example of the attribute specifying device described later.

Then, the displaying device is controlled by the controlling device including, for example, a recording circuit and an arithmetic circuit, to change the floating image into the form which is associated with the detected attribute of the detected object in advance. For example, a form that “a character depicted in the floating image is scared” is associated in advance with the attribute of the toy gun, which is a tool for “opening fire”. Alternatively, a form that “pasta is displayed on a plate depicted in the floating image” is associated in advance with the attribute of the fork, which is a tool for “sticking and rolling food”. As described above, in accordance with the detected attribute of the detected object, the floating image is changed into various forms which can be derived from the attribute.

Therefore, according to the present invention, it is possible to display the stereoscopic two-dimensional image, relatively easily, and it is also possible to improve the rendering effect and interactivity.

In one aspect of the image display apparatus of the present invention, the attribute specifying device has an attribute detecting device for detecting the attribute.

According to this aspect, the attribute of the detected object is detected by the attribute detecting device in the following manner; namely, the IC tag in which the attribute is recorded in advance is attached to the detected object, and the IC tag is read by an IC tag reader in an electromagnetic-optic manner, to thereby detect the attribute of the detected object. Alternatively, pattern recognition is performed on the image of the detected object imaged by an imaging apparatus such as a CCD camera and a database of candidate images of the detected object, and the attribute recorded in association with the candidate of the detected object is read, to thereby detect the attribute of the detected object.

In another aspect of the image display apparatus of the present invention, the image display apparatus is further provided with a position detecting device for detecting where the position of the detected object is in the real space portion, and the controlling device controls the displaying device to change the floating image into a form which is also associated with the detected position of the detected object in advance, in addition to the specified attribute.

According to this aspect, as described later, it is also possible to dramatically improve reality in addition to the rendering effect and interactivity. In other words, firstly, where the position of the detected object is in the real space portion is detected by the position detecting device such as an XYZ sensor, a CCD image sensor, an infrared sensor, or an ultrasound sensor. The “position of the detected object” herein includes not only a planar position of the detected object but also a spatial position. For example, if the detected object crosses the image formation surface or planes before or behind the image formation surface, a planar area occupied by the detected object may be detected in the image formation surface or the planes before or behind the image formation surface. In addition to or instead of the planar areas, if the detected object is located in the real space portion including the aforementioned space, a spatial area occupied by the detected object in the real space portion may be detected. Then, the displaying device is controlled by the controlling device to change the floating image into the form which is also associated with the detected position of the detected object in advance, in addition to the specified attribute of the detected object. For example, if a “toy bullet” passes through a “floating image of a target”, the displaying device is controlled by the controlling device to change the “floating image of the target” to a “floating image of a target with a bullet hole”. As described above, the floating image is dynamically changed in accordance with the position of the detected object, so that it is possible to improve the rendering effect and interactivity. In addition, at this time, the “bullet hole” is not located at an arbitrary position but adjusted to a position where “toy bullet” penetrates, so that it is possible to dramatically improve reality.

In an aspect in which the position of the detected object is detected, the image display apparatus may be further provided with a memory device for storing a track of the position of the detected object changed, if the detected position of the detected object changes with time, and the controlling device may control the displaying device to change the floating image into a form which is also associated with the stored track of the position of the detected object in advance, in addition to the specified attribute.

According to this aspect, as described later, it is also possible to dramatically improve reality in addition to the rendering effect and interactivity. In other words, firstly, if the detected position of the detected object changes with time, the track of the position of the detected object changed is stored by the memory device, which is formed of an arithmetic-logic circuit, centered on a memory apparatus, for example, every several hundred milliseconds. The “track of the position of the detected object changed” herein includes not only a planar position of the detected object but also a spatial track. In addition, it may indicate a track that satisfies a predetermined condition, such as a track when the detected object crosses the image formation surface or the planes before or behind the image formation surface. Then the displaying device is controlled by the controlling device to change the floating image into the form which is also associated with the stored track of the position of the detected object in advance, in addition to the specified attribute of the detected object as described above. For example, if a “floating image of an apple” is vertically cut with a knife with it crossing the image formation surface, the track of the cutting is stored. Then, the displaying device is controlled by the controlling device to change the “floating image of the apple” to a “floating image of an apple with a cut” which is associated in advance with the attribute of the knife. At this time, the “cut” is not located at an arbitrary position but adjusted to a position where the knife penetrates. Moreover, since the track is stored, it does not vanish when the position of the knife is changed. Thus it is possible to dramatically improve reality.

In an aspect in which the track of the position is stored, the image display apparatus may be further provided with a predicting device for predicting where the position of the detected object is changed to in the real space portion, on the basis of the stored track of the position of the detected object, and the controlling device may control the displaying device to foresee the image in a form which is also associated with the predicted position of the detected object in advance, in addition to the specified attribute.

According to this aspect, as described later, it is possible to improve the rendering effect and interactivity, and it is also possible to solve a response delay in displaying the floating image. In other words, firstly, the track of the position of the detected object changed as described above is stored by the memory device, for example, every several hundred milliseconds. Then, where the position of the detected object is changed to in the real space portion after the time point that the position of the detected object is detected (typically the newest detection in detecting the position a plurality of times) is predicted by the predicting device which is formed of an arithmetic circuit, on the basis of the stored track of the position of the detected object. For example, by specifying a velocity vector on the basis of the track of the position of the detected object stored with time, it is also possible to predict the subsequent track. Then, the displaying device is controlled by the controlling device to foresee the image in the form which is also associated with the predicted position of the detected object in advance, in addition to the specified attribute of the detected object. As described above, it is possible to solve the response delay by predicting the displacement of the position not only from the current position of the detected object but also from the track and by foreseeing the image in advance in accordance with the prediction result. As a result, it is possible to reduce a sense of discomfort, such as a later-coming change in the floating image or changing a little behind the displacement of the detected object.

In another aspect of the image display apparatus of the present invention, the image display apparatus is further provided with a status detecting device for detecting a status of the detected object, and the controlling device controls the displaying device to change the floating image into a form which is also associated at least with the detected status of the detected object in advance, in addition to the specified attribute.

According to this aspect, as described later, the floating image is changed in accordance with the status of the detected object or its change, so that it is possible to further improve the rendering effect and interactivity. In other words, firstly, the status of the detected object is detected by the status detecting device. The “status of the detected object” herein qualitatively or quantitatively indicates sonic status about the detected object. For example, it indicates a discontinuous two-step status, such as the ON/OFF of a switch, a continuous multistage status, such as low, middle, and high volume, or similar statuses. Then, the displaying device is controlled by the controlling device to change the floating image into the form which is also associated at least with the detected status of the detected object in advance, in addition to the specified attribute of the detected object. For example, if the switch of the toy gun is changed from OFF to ON, it is regarded as opening fire, and the displaying device is controlled by the controlling device to change the “floating image of the target” to the “floating image of the target with the bullet hole”. Alternatively, if the switch of a dryer is changed from OFF to ON, a “floating image of a woman with long hair” may be changed to a “floating image of a woman with flowing hair”, which is associated in advance with the attribute of the “dryer”. As described above, the floating image is dynamically changed in accordance with the status of the detected object, so that it is possible to further improve the rendering effect and interactivity.

In another aspect of the image display apparatus of the present invention, the image display apparatus is further provided with a tag device which is attached to the detected object and in which attribute information indicating the attribute of the detected object is recorded readably in an electromagnetic-optic manner, and the attribute detecting device detects the attribute by reading the recorded attribute information in an electromagnetic-optic manner.

According to this aspect, as described later, the attribute information about the detected object can be read by using the tag device, and the rendering effect and interactivity can be improved on the basis of the read attribute information. In other words, firstly, the tag device such as an IC tag or a barcode is attached to the detected object. In the tag device, the attribute information which indicates the attribute of the detected object is recorded readably in an electromagnetic-optic manner. The expression “readably in an electromagnetic-optic manner” herein indicates that the attribute information recorded in the tag device can be read using electricity, magnetism, or light. Then, the attribute information is read in an electromagnetic-optic manner by the attribute detecting device, such as an IC tag reader or a barcode reader, and the attribute of the detected object is detected using the attribute information. For example, it is possible to read the aforementioned attribute information electromagnetically by irradiating a circuit in the IC tag with an electromagnetic wave, or optically by image-recognizing the barcode. Incidentally, a reading form is preferably of noncontact type; however, it may be also of a contact type. In any cases, it is possible to read the attribute information using the tag device, and it is possible to improve the rendering effect and interactivity on the basis of the read attribute information.

In an aspect in which the tag device is further provided, the position detecting device may detect the position of the detected object by detecting where a position of the tag device attached to the detected object is in the real space portion.

According to this aspect, as described later, if a barcode reader or an IC tag reader is used that is specialized for the detection of the tag device, it can detect the position in addition to the attribute, so that it serves a dual purpose. In other words, where the position of the tag device attached to the detected object is in the real space portion is detected by the position detecting device, such as an IC tag and a barcode, and this allows the position of the detected object to be detected. Specifically, if an electromagnetic wave is emitted toward the IC tag, the position of the detected object is detected from its response time and response direction. In this manner, it is possible to receive the effect that the dual purpose is served as described above. Incidentally, by attaching a plurality of tag devices to the detected object, the direction may be detected in addition to the position of the detected object. At this time, since the floating image can be changed in accordance with not only the position but also the direction, the interactivity of the floating image is further improved.

In an aspect in which the tag device is further provided, in addition to the attribute information, status information indicating a status of the detected object may be recorded readably in an electromagnetic-optic manner in the tag device, and the image display apparatus may be further provided with a rewriting device for rewriting at least the status information.

According to this aspect, as described later, if a barcode reader or an IC tag reader is used that is specialized for the detection of the tag device, it can detect the status in addition to the attribute, so that it serves a dual purpose. In other words, in the tag device, the status information indicating the status of the detected object is also recorded readably in an electromagnetic-optic manner in addition to the attribute of the detected object. Then, at least the status information is rewritten by the rewriting device, such as an IC tag writer or a barcode writer. For example, if the switch of the toy gun is changed from OFF to ON, the status information recorded in the IC tag is rewritten from the content indicating OFF to the content indicating ON. Then, the rewritten status information is detected by the status detecting device, and the “floating image of the target” is changed to the “floating image of the target with the bullet hole”, as described above. In this manner, it is possible to receive the effect that the dual purpose is served, as described above, so that it is extremely useful in practice.

In another aspect of the image display apparatus of the present invention, the image transmitting device is provided with a microlens array, and the floating image is displayed as a real image of the image.

According to this aspect, as described later, since the floating image is the real image, there is no sense of discomfort even if the detected object (e.g. knife) is disposed at the position of the floating image. Thus, direct interactive can be provided for the floating image. In other words, firstly, the image transmitting device is formed of a microlens array. The “microlens array” herein is constructed in the 3D floating vision method, and it is constructed by unifying one or a plurality of lens array halves, each including a plurality of micro convex lenses arranged in a two-dimensional matrix. According to such an image transmitting device, the floating image is displayed as the real image of the image (preferably, erected image).

Incidentally, a different method from the image display apparatus of the present invention can also realize a naked-eye stereoscopic system; however, unlike the image display apparatus of the present invention, it is hard to touch the floating image with the hand without a sense of discomfort.

As the method of realizing the stereoscopic system without using exclusive glasses, there are a view-angle barrier method, a lenticular method, and the like, as representative examples; however, stereoscopic vision is realized by a virtual image which is caused by showing a right-eye image to the right eye and by showing a left-eye image to the left eye in any of the methods, and the focal position of the eyes of the observer is different from a position at which the floating image is perceived. In other words, in seeing the vision which emerges in front of the image display surface, although the focal position of the eyes is placed on the imaged display surface, the stereoscopic vision which emerges in front is actually perceived. (This is said to cause eyestrain.) Hence, if the detected object (e.g. knife) is brought close to the stereoscopic vision to touch, the focal position of the eyes is displaced from the image display surface to the position of the detected object which is to touch the stereoscopic vision (virtual image). Thus, it is hard to accurately visually recognize the floating image.

Thus, in the vision-angle barrier method and the lenticular method, there is a sense of discomfort in no small way in cases where the floating image is directly touched.

In contrast, the floating image displayed by the image display apparatus of the present invention is the real image formed by the microlens array, and the focal position of the eyes is placed on the position of the floating image from the beginning. Thus, even if the detected object is brought to the position of the floating image, it is possible to easily recognize that it is touched directly without a sense of discomfort.

As explained above, according to the image display apparatus of the present invention, it is provided with the displaying device, the image transmitting device, the attribute specifying device, and the controlling device. Thus, it is possible to display the stereoscopic two-dimensional image, relatively easily, and it is also possible to improve the rendering effect and interactivity.

The operation and other advantages of the present invention will become more apparent from the embodiments explained below.

### BRIEF DESCRIPTION OF DRAWINGS

FIG. 1 is a perspective view showing the basic structure of an image display apparatus which can display a floating image in an embodiment.

FIG. 2 is a view showing the image display apparatus in the embodiment, viewed from A-A in FIG. 1.

FIG. 3 is a cross sectional view schematically showing the structure of an image transmission panel.

FIG. 4 is a cross sectional view schematically showing the structure of the image transmission panel and the direction of the image (two pieces).

FIG. 5 are cross sectional views schematically showing the structure of the image transmission panel and the direction of the image (a: one piece, b: three pieces).

FIG. 6 is a block diagram conceptually showing the basic structure of an image display apparatus in a first embodiment.

FIG. 7 is a flowchart showing the basic operation of the image display apparatus in the first embodiment.

FIG. 8 is a schematic diagram for explaining the basic operation of the image display apparatus in the first embodiment (a toy gun 120 a: does not exist, b: exists)

FIG. 9 is a block diagram conceptually showing the basic structure of an image display apparatus in a second embodiment.

FIG. 10 is a flowchart showing the basic operation of the image display apparatus in the second embodiment.

FIG. 11 are perspective views for explaining statuses before and after a toy bullet passes through an image formation surface on the image display apparatus in the second embodiment (a: before passing, b: after passing in a comparison example, c: after passing in the second embodiment).

FIG. 12 are side views for explaining the statuses before and after the toy bullet passes through the image formation surface, on the image display apparatus in the second embodiment (a: before passing, b: after passing in the comparison example, c: after passing in the second embodiment).

FIG. 13 are schematic diagrams showing that a fork is stuck into the floating image, on the image display apparatus in the second embodiment (a: a perspective view, b: a front view showing a change in the floating image).

FIG. 14 are schematic diagrams showing that the floating image is cut with a knife, on the image display apparatus in the second embodiment (a: a perspective view, b: a front view showing a change in the floating image).

FIG. 15 are schematic diagrams showing that the movement of the knife is predicted and the floating image is foreseen when the floating image is cut with the knife, on the image display apparatus in the second embodiment (a: a case where it is cut along a route P0-P1, b: a case where it is cut along a route Q0-Q1).

FIG. 16 is a block diagram conceptually showing the basic structure of an image display apparatus in a third embodiment.

FIG. 17 is a flowchart showing the basic operation of the image display apparatus in the third embodiment.

### DESCRIPTION OF REFERENCE CODES

1 image display apparatus
11 display device
111 image display surface
13 floating image
15 space
17 image transmission panel
21 image formation surface
23 micro convex lens
231, 232 micro convex lens
24 transparent substrate
25 microlens array
251, 252 lens array half
112 display drive device
17 image transmission panel
60 attribute detection device
100 control apparatus
101 control device
102 image generation device
103 memory device
120 toy gun
121 toy bullet
122 fork
123 knife
124 lipstick
125 dryer
126 brush
50 to 56 IC tag
31 audio output device
32 audio drive device
61 position detection device
62 status detection device
55 rewriting device

### BEST MODE FOR CARRYING OUT THE INVENTION

Hereinafter, the best mode for carrying out the invention will be explained in each embodiment in order, with reference to the drawings.

(Basic Principle)

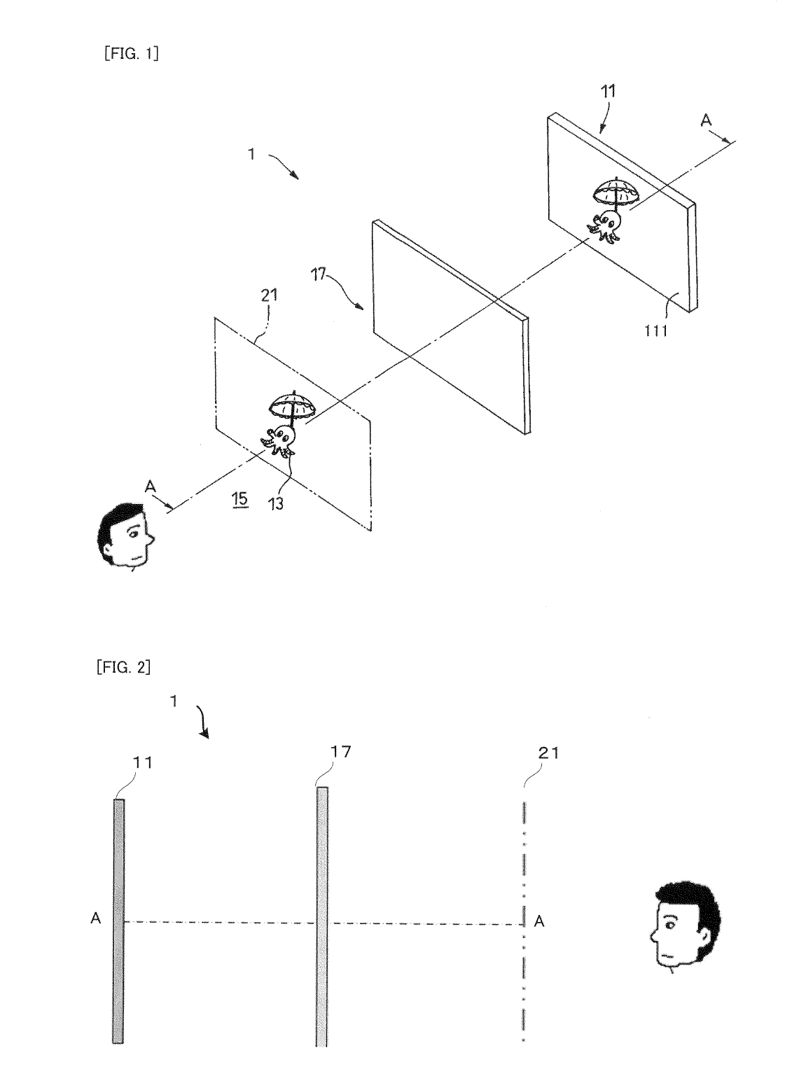

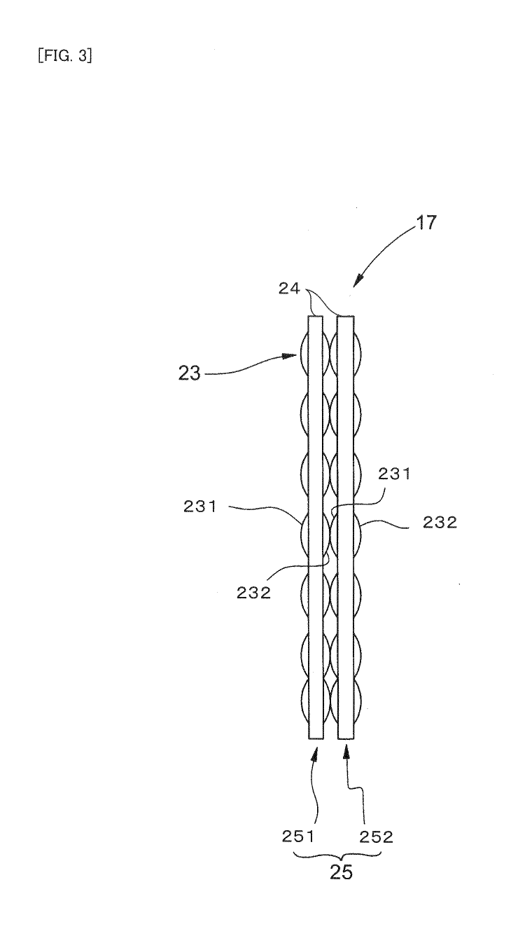

Firstly, before the explanation of an image display apparatus in embodiments, the basic structure of the image display apparatus which can display a floating image will be explained with reference to FIG. 1 and FIG. 2. FIG. 1 is a perspective view showing the basic structure of the image display apparatus which can display a floating image in an embodiment. FIG. 2 is a view showing the image display apparatus in the embodiment, viewed from A-A in FIG. 1.

As shown in FIG. 1, an image display apparatus 1 in the embodiment is provided with a display device 11 having an image display surface 111; and an image transmission panel 17, and it displays a floating image 13 on an image formation surface 21 in a space 15 on the opposite side to the display device 11. Incidentally, in the embodiment, the display device 11 corresponds to one example of the “first displaying device” of the present invention, and the image transmission panel 17 corresponds to one example of the “image transmitting device” of the present invention.

The display device 11 is, for example, a color liquid crystal display apparatus (LCD). The display device 11 is provided with a color liquid crystal drive circuit (not illustrated), a backlight illumination device (not illustrated), and the like, and it displays a two-dimensional image on the image display surface 111. The color liquid crystal drive circuit outputs a display drive signal on the basis of a video signal inputted from the exterior. The backlight illumination device illuminates the image display surface 111 from the rear if the display device 11 is not of a spontaneous luminescence type. The image display surface 111 displays the two-dimensional image, for example, by changing the direction of liquid crystal molecules and increasing or decreasing light transmittance, on the basis of the outputted display drive signal. Incidentally, the displayed two-dimensional image is eventually displayed as the floating image, so that it is preferably drawn stereoscopically to have depth effect. As the display device 11, various display apparatuses, such as a cathode-ray tube, a plasma display, or an organic electroluminescence display, may be used instead of the color liquid crystal display apparatus (LCD).

The image transmission panel 17 is formed of, for example, a microlens array (which will be detailed later with reference to FIG. 3), as shown in FIG. 2, and it is alienated from the display device 11. Moreover, the image transmission panel 17 allows the light emitted from the image display surface 111 of the display device 11 (i.e. the display light which constitutes the two-dimensional image) to form an image on the image formation surface 21 in the space 15, to thereby display the floating image 13. Here, the image formation surface 21 is a plane virtually set on the space in accordance with the operation distance of the microlens array, and it is not a real object. Back in FIG. 1, the floating image 13 formed on the image formation surface 21 is displayed with it floating in the space, and thus, for a viewer, it looks like a stereoscopic image is displayed. In other words, the floating image 13 is recognized for the viewer as a pseudo stereoscopic image. In order to strengthen this tendency, the two-dimensional image displayed on the display device 11 may be provided with depth in advance, or the contrast of the two-dimensional image may be emphasized by blacking the background image on the image display surface 111.

As described above, since the image display apparatus 100 is constructed as shown in FIG. 1 and FIG. 2, it is possible to display the floating image 13 on the image formation surface 21 as if the stereoscopic image were displayed.

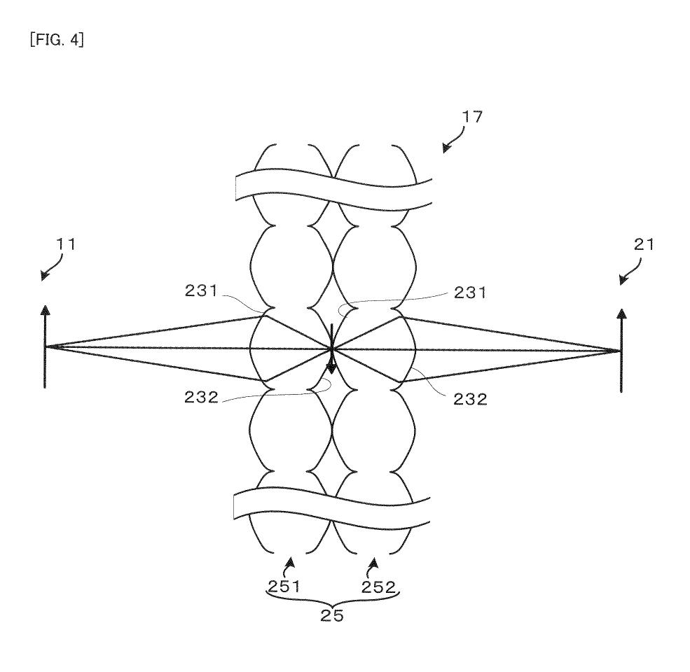

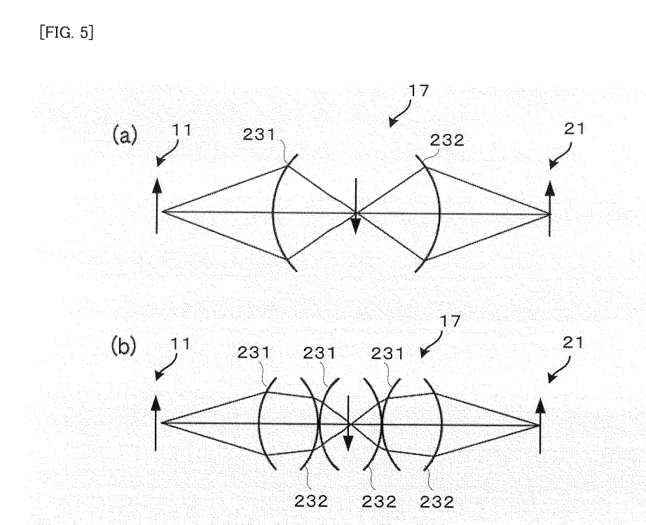

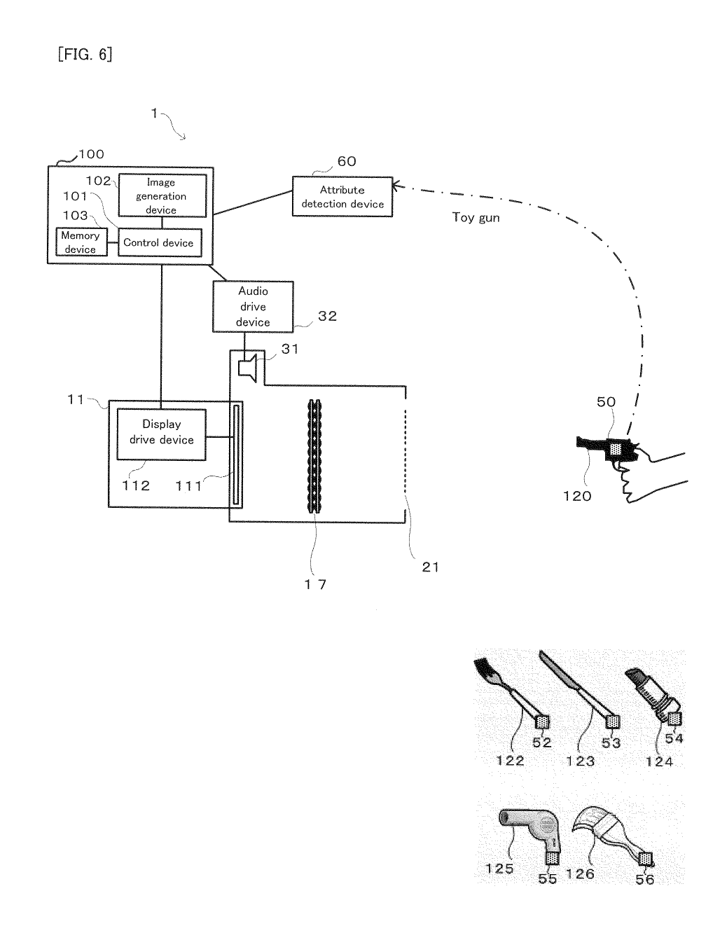

Next, with reference to FIG. 3 to FIG. 5, the detailed structure of the image transmission panel 17 will be explained. FIG. 3 is a cross sectional view schematically showing the structure of the image transmission panel. FIG. 4 is a cross sectional view schematically showing the structure of the image transmission panel and the direction of the image (two pieces). FIG. 5 are cross sectional views schematically showing the structure of the image transmission panel and the direction of the image (a: one piece, b: three pieces).

As shown in FIG. 3, the image transmission panel 17 is formed of a microlens array 25.

The microlens array 25 is formed, for example, by unifying two pieces of lens array halves 251 and 252.

Each of the lens array halves 251 and 252 has a plurality of micro convex lenses 23 arranged in a two-dimensional matrix on the both sides of a transparent substrate 24, which is made of glass or resins excellent in light transmittance. Each micro convex lens is disposed such that each of the optical axes of micro convex lenses 231 arranged on one side of the transparent substrate 24 matches respective one of the optical axes of micro convex lenses 232 located at opposed positions on the other side. In addition, the lens array halves are overlapped so as to match the optical axes of the adjacent micro convex lenses 232 and 231 between the lens array halves 251 and 252.

Moreover, the image transmission panel 17 is placed a predetermined clearance (operating distance of the microlens array 25) away from and opposed to the image display surface 111 of the display device 11.

Therefore, the image transmission panel 17 transmits the display light of the two-dimensional image, emitted from the image display surface 111 of the display device 11, to the space 15 on the opposite side to the display device 11 and forms an image on the image formation surface 21 which is a predetermined distance away from the image transmission panel 17. As a result, the image transmission panel 17 can display the two-dimensional image displayed by the display device 11, as the floating image 13.

Here, as shown in FIG. 4, the two-dimensional image displayed by the display device 11 is vertically reversed once on the lens array half 251, and again reversed once on the lens array half 252 before it is emitted. By this, the image transmission panel 17 can display the erected image of the two-dimensional image, as the floating image 13.

Incidentally, if the erected image can be obtained as the floating image 13, the structure of the microlens array 25 is not limited to what the two pieces of lens array halves 251 and 252 are unified as a pair. For example, it may be formed of one piece as shown in FIG. 5(a), or it may be formed of two or more pieces as shown in FIG. 5(b).

As described above, if the image transmission panel 17 is constructed as shown in FIG. 3 to FIG. 5, the image display apparatus 100 can preferably display the floating image 13, for example, as the erected image.

### (1) First Embodiment

Next, with reference to FIG. 6 to FIG. 8, an explanation will be given on the structure and the operation process of the image display apparatus in the first embodiment, which can display the floating image on the basis of the basic principle described above.

### (1-1) Structure

Firstly, the structure of the image display apparatus in the embodiment will be explained with reference to FIG. 6. FIG. 6 is a block diagram conceptually showing the basic structure of the image display apparatus in the first embodiment.

As shown in FIG. 6, the image display apparatus 1 in the embodiment is provided with the display device 11, the image transmission panel 17, an audio output device 31, an audio drive device 32, an attribute detection device 60, and a control apparatus 100. Incidentally, in the embodiment, the attribute detection device 60 corresponds to one example of the “attribute specifying device” of the present invention, and the control apparatus 100 corresponds to one example of the “controlling device” of the present invention.

The display device 11 is, for example, a color liquid crystal display apparatus, and it is provided with the image display surface 111 and a display drive device 112. The display drive device 112 outputs a display drive signal on the basis of a video signal inputted from the control apparatus 100, and it displays a two-dimensional image which is a motion picture or a still image on the image display surface 111.

The image transmission panel 17, as described above using FIG. 1 to FIG. 4, is disposed on the optical path of the display light which constitutes the two-dimensional image displayed on the screen of the display device 11, and it transmits the display light of the display device 11 so as to display a real image (i.e. the floating image) of the two-dimensional image on the image formation surface 21, which is located in a space on the opposite side to the screen of the display device 11. In this manner, 3D image display or stereoscopic image display is performed by the 3D floating vision method. For example, viewed from an observer located in front of the screen of the display device 11 through the image transmission panel 17, the real image is seen as if it was floating on the image formation surface 21 on the front side of the image transmission panel 17.

The audio output device 31 is, for example, a speaker, and it generates an audible sound by changing a music signal inputted from the audio drive device 32 to machine vibration.

The attribute detection device 60 is an image recognizing apparatus or an IC tag reader or the like, and it detects the attribute of a detected object which exists in its detectable range (e.g. several cm to several tens cm). The detected object herein is, for example, a toy gun 120, a fork 122, a knife 123, a lipstick 124, a dryer 125, or a brush 126, and it is preferably an instrumental object having a unique attribute (e.g. a shape, a function, a concept, or the like). The attribute detection device 60 detects the attribute unique to the detected object in various methods. For example, if the attribute detection device 60 is provided with an imaging element, such as a CCD camera, the attribute may be detected by verifying the image of the detected object imaged with the images of tools accumulated with the attributes in an image database in advance. In particular, it is easy to detect the attribute by limiting the number of candidates which can be detected in advance. Alternatively, if the attribute detection device 60 is the IC tag reader, the attribute may be detected by attaching unique attribute identification IC tags 50 to 56 to the respective detected objects and by reading the IC tag, as shown in FIG. 6. The “IC tag” herein is a generic term of a small information chip which is several microns to several millimeters square, and it corresponds to one example of the “tag device” of the present invention. In the IC tag circuit, a slight amount of electric power is generated by an electric wave emitted from the IC tag reader, and the electric power allows information to be processed and to be transmitted to the reader. In most cases, the IC tag and the IC tag reader need to be closer, due to a relation with the output of the electric wave to be used or the like; however, they are not necessarily in contact with each other.

The control apparatus 100 is provided with a control device 101, an image generation device 102, and a memory device 103. Incidentally, in the embodiment, the memory device 103 corresponds to one example of the “memory device” of the present invention, and the control apparatus 100 corresponds to one example of the “predicting device” of the present invention.

The control device 101 is provided with, for example, a known central processing unit (CPU), a read-only memory (ROM) for storing a control program therein, a random access memory (RAM) for storing various data therein, and an arithmetic-logic circuit, centered on a memory apparatus, for storing and generating data for display image or the like. The image generation device 102 generates data about display images or the like. The memory device 103 stores the attribute of the detected object detected by the attribute detection device 60; an image and a sound displayed in accordance with the attribute; or a history of the position associated to the detected object which is displaced; or the like. The attribute of the detected object detected by the attribute detection device 60 is inputted to the control apparatus 100 as an electric signal through a bus not-illustrated. On the other hand, it outputs a video signal to the display drive device 112 or an audio signal to the audio drive device 32.

### (1-2) Operation

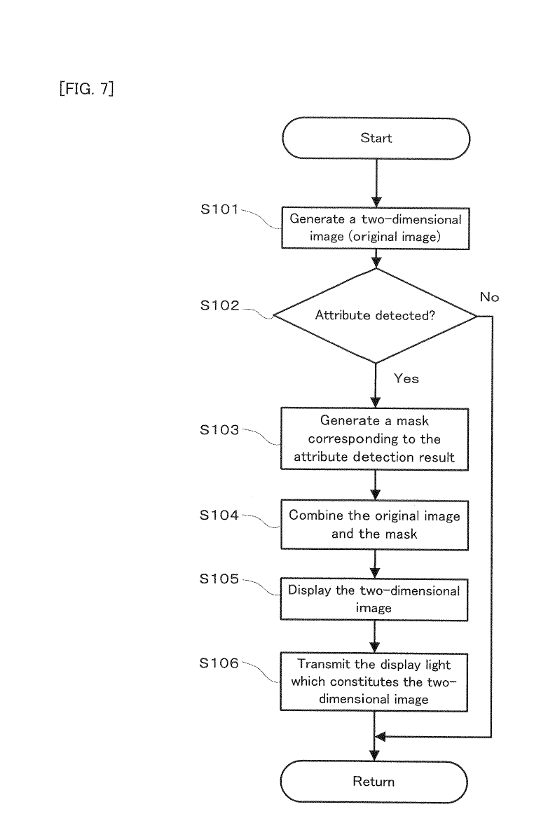

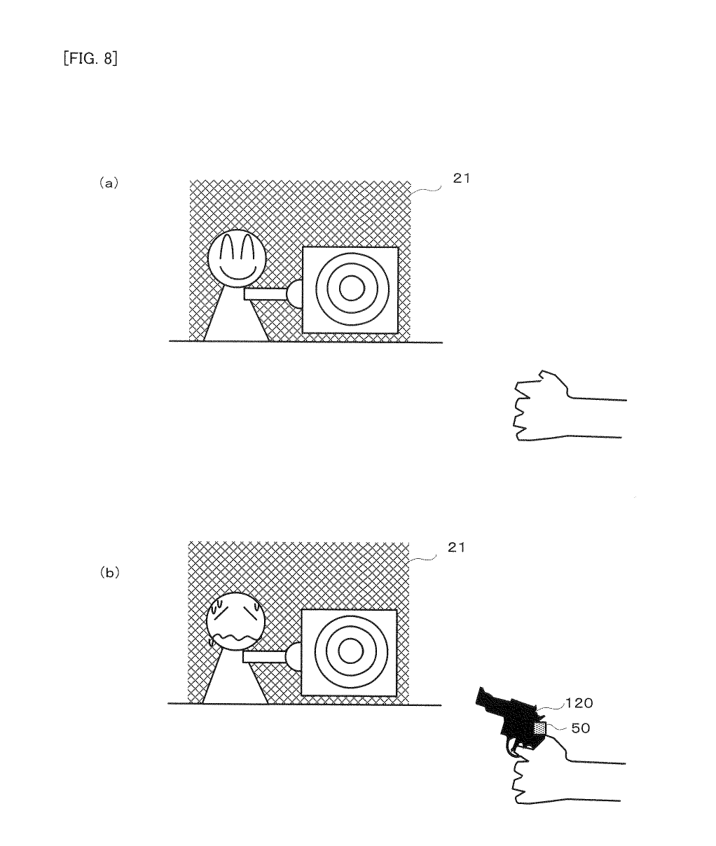

Next, the basic operation of the image display apparatus in the embodiment constructed in the above manner will be explained with reference to FIG. 7 and FIG. 8 in addition to FIG. 6. FIG. 7 is a flowchart showing the basic operation of the image display apparatus in the first embodiment. FIG. 8 is a schematic diagram for explaining the basic operation of the image display apparatus in the first embodiment (a toy gun 120 a: does not exist, b: exists)

In FIG. 7, firstly, the control apparatus 100 enables the image generation device 102 to generate a two-dimensional image (original image) (step S101). For example, it is assumed, as shown in FIG. 8(a), that the original image is an image of a doll with a target.

Then, it is judged whether or not the attribute of the detected object is detected by the attribute detection device 60 (step S102).

If the attribute of the detected object is not detected at all (the step S102: NO), for example, if the detected object does not exist in the datable range of the attribute detection device 60, there is no need to particularly change the original image. Therefore, the original image of the doll is displayed to have a normal face or a smile, as shown in FIG. 8(a).

On the other hand, if the attribute of the detected object is detected (the step S102: YES), the following process is performed in accordance with the detected attribute. Incidentally, the case where the attribute of the detected object is detected is as follows: a case where a user has a toy gun 120, which is one example of the detected object, in the detectable range of the attribute detection device 60, and the IC tag 50 with the attribute of the toy gun 120 written is read by the attribute detection device 60 to detect the attribute.

Firstly, a mask image corresponding to the detected attribute is generated by the image generation device 102 (step S103). The association, i.e. what the mask image corresponding to the detected attribute is like, is stored in advance in the memory device 103. For example, as shown in FIG. 8(b), the toy gun 120 is a tool for opening fire, so that a mask image depicting a status of “being scared” is associated and stored. As examples of the mask images corresponding to other detected objects, the followings can be considered. The fork 122 is a tool for sticking and rolling food, so that a mask image depicting a status of “being hungry” is associated and stored. The knife 123 is a tool for cutting food, so that a mask image depicting a status of “being hungry” is associated and stored. The lipstick 124 is a tool for wearing lipstick, so that a mask image depicting a status of “being happy” is associated and stored. The dryer 125 is a tool for blowing hair with hot air, so that a mask image depicting a status of “feeling hot” is associated and stored. The brush 126 is a tool for painting in various colors, so that a mask image depicting a status of “being excited” is associated and stored.

Then, the original image and the mask image are combined (step S104). The control device 101 transmits a video signal to the display drive device 112 such that the combined two-dimensional image is displayed by the display device 11. In response to the video signal, the display device 11 displays the two-dimensional image after the combination (step S105). Then, the display light which constitutes the displayed two-dimensional image is transmitted by the image transmission panel 17 disposed on the optical path of the display light, and it is displayed as the real image on the image formation surface 21 through the image transmission panel 17 (step S106).

As described above, according to the embodiment, it is possible to display the stereoscopic two-dimensional image, relatively easily, and it is also possible to improve the rendering effect and interactivity. In particular, the attribute of the detected object can be detected, so that not uniform but various reactions can be realized in accordance with the attribute. Thus, the rendering effect as the stereoscopic image becomes enormous.

### (2) Second Embodiment

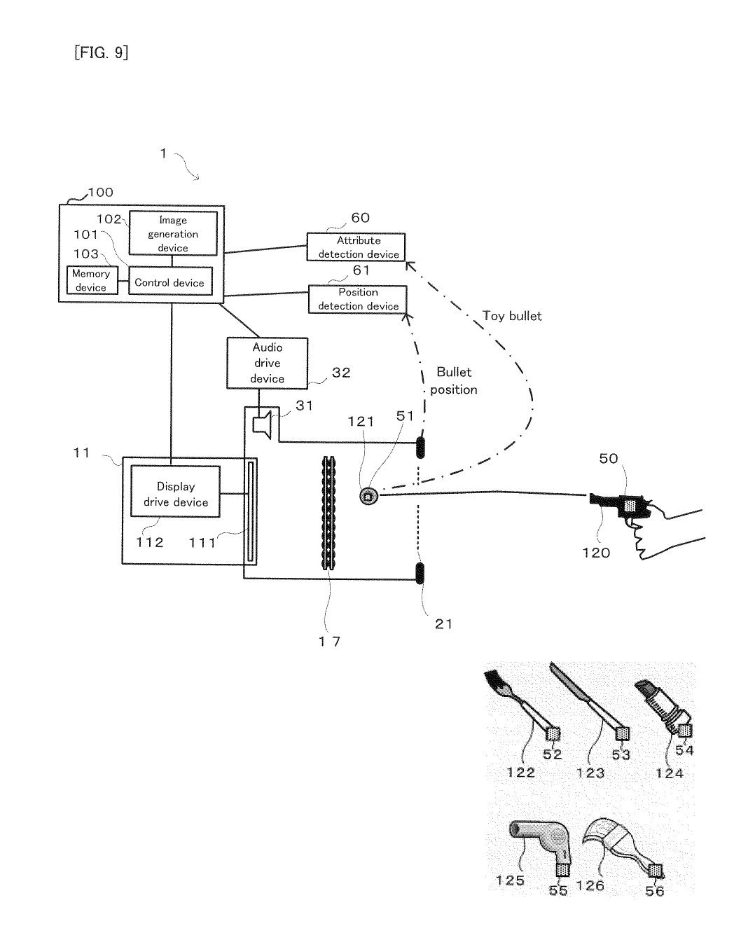

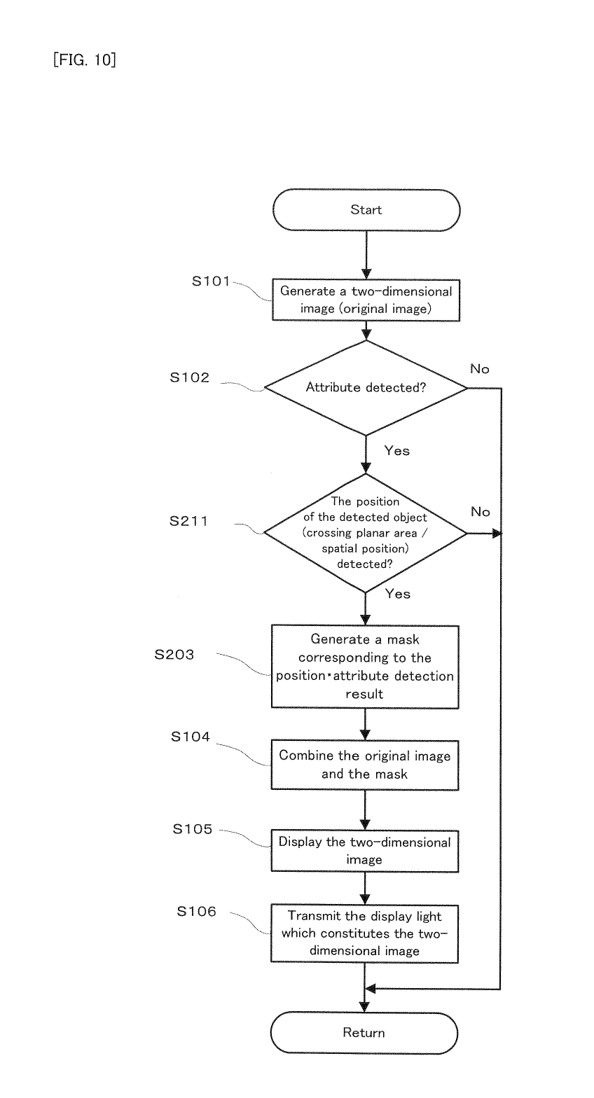

An image display apparatus in a second embodiment will be explained with reference to FIG. 9 to FIG. 15.

### (2-1) Structure

Firstly, the basic structure of the image display apparatus in the embodiment will be explained with reference to FIG. 9. FIG. 9 is a block diagram conceptually showing the basic structure of the image display apparatus in the second embodiment.

Incidentally, in FIG. 9, the same constituents as those in the aforementioned first embodiment (i.e. FIG. 6) carry the same reference numerals, and their explanation will be omitted as occasion demands.

In FIG. 9, the image display apparatus 1 in the embodiment is further provided with a position detection device 61 for detecting the position of a detected object, in addition to the constituents of the image display apparatus 1 in the first embodiment described above. Incidentally, the position detection device 61 corresponds to one example of the “position detecting device” of the present invention.

For example, if the toy gun 120 is fired and if the toy bullet 121 which incorporates the IC tag 51 with the attribute written crosses the image formation surface 21, the position detection device 61 can detect the crossed planar area and transmit the detection result to the control apparatus 100. The position detection device 61 is, for example, various noncontact sensors, a camera-type sensor, and the like. Incidentally, the planar area detected by the position detection device 61 does not necessarily match the image formation surface 21, and it may be located before or behind the image formation surface 21.

Alternatively, the position detection device 61 can detect a spatial position of the toy gun 120 in the detectable range in addition to or instead of the planar area and can transmit the detection result to the control apparatus 100. In this case, the position detection device 61 may be replaced by, for example, various sensors such as a XYZ sensor, a CCD image sensor, disposed to capture the image formation surface from the front, an infrared sensor, or an ultrasound sensor, as well as a sensor for detecting the planar areas arranged at predetermined intervals. Alternatively, the detection result from one position detection device 61 may be temporarily accumulated in a memory built in or externally attached to the control apparatus 100, and the toy bullet 121 which has passed through the image formation surface 21 may be detected as a set of the planar areas.

Incidentally, the detection of the planar position and the detection of the spatial position as described above may be static or dynamic, and it is possible to adopt an aspect according to the application. In other words, the planar position and the spatial position may be detected from the shape of the detected object and position information registered in advance in the memory, or they may be detected in real time by various sensors such as a XYZ sensor.

### (2-2) Operation

Next, the operation in the embodiment constructed in the above manner will be explained with reference to FIG. 10 in addition to FIG. 9. FIG. 10 is a flowchart showing the basic operation of the image display apparatus in the second embodiment.

In FIG. 10, firstly, the control apparatus 100 enables the image generation device 102 to generate a two-dimensional image (original image) (the step S101). For example, it is assumed, as shown in FIG. 8(a), that the original image is an image of a doll with a target.

Then, it is judged whether or not the attribute of the detected object is detected by the attribute detection device 60 (the step S102). If the attribute of the detected object is detected (the step S102: YES), it is further judged whether or not the position of the detected object is detected by the position detection device 61 (step S211).

If the position of the detected object is detected (the step S211: YES), the following process is performed in accordance with the detected position and the attribute. Incidentally, the case where the position of the detected object and the attribute are detected is as follows: a case where the user fires the toy bullet 121, which incorporates the IC tag 51 with the attribute written, toward the image formation surface 21 with the toy gun 120, and as a result, the toy bullet 121 reaches in the detectable range of the position detection device 61 and the attribute detection device 60.

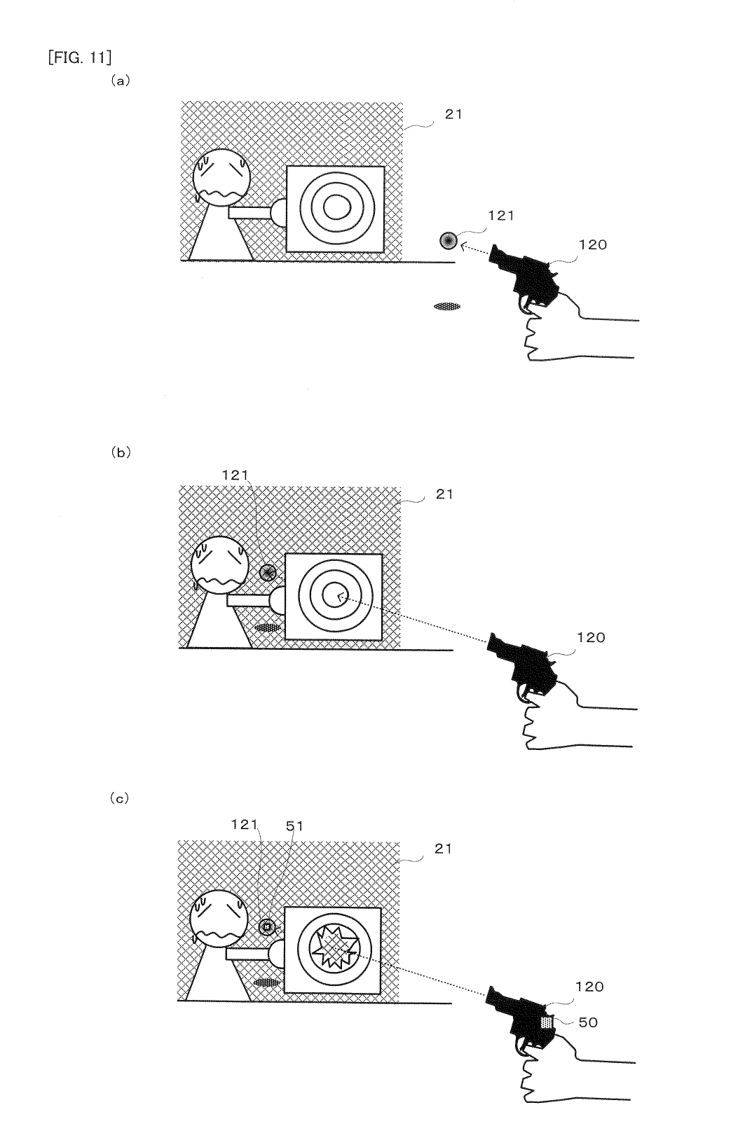

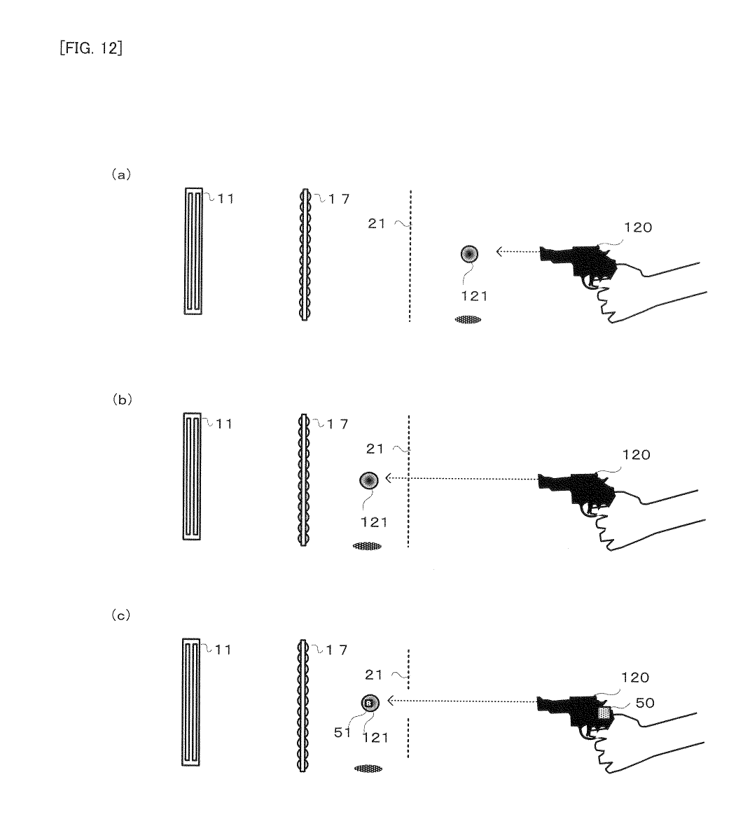

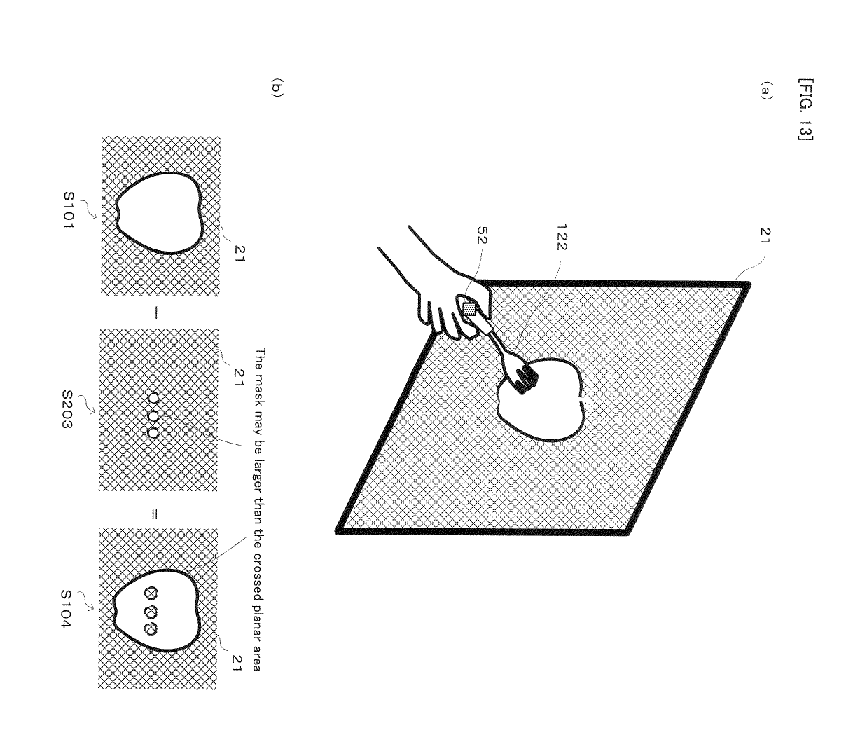

Firstly, a mask image corresponding to the position of the detected toy bullet 121 and the attribute is generated by the image generation device 102 (step S203). Then, as in the first embodiment, the processes in the steps S104, S105, and S106 are performed, and the floating image is preferably changed in response to the position of the detected toy bullet 121 and the attribute. This will be explained with reference to FIG. 11 and FIG. 12. FIG. 11 are perspective views for explaining statuses before and after the toy bullet passes through the image formation surface on the image display apparatus in the second embodiment (a: before passing, b: after passing in a comparison example, c: after passing in the second embodiment). FIG. 12 are side views for explaining the statuses before and after the toy bullet passes through the image formation surface, on the image display apparatus in the second embodiment (a: before passing, b: after passing in the comparison example, c: after passing in the second embodiment).

As shown in FIG. 11(a) and its side view, FIG. 12(a), it is assumed that the toy bullet 121 is fired from the toy gun 120. At this time, the toy bullet 121 passes through the floating image of the target, displayed on the image formation surface 21. If no measures are taken, there is a sense of discomfort as seen in FIG. 11(b) and its side view, FIG. 12(b). In other words, although the toy bullet 121 passes through the floating image of the target, there is no change in the floating image of the target, and thus there is a sense of discomfort. Alternatively, the interactivity is not felt.

Thus, in the embodiment, in order to remove the sense of discomfort, a mask image of “a bullet hole” is generated on the basis of the attribute of the toy bullet 121, and the position of the “bullet hole” on the image formation surface 21 is determined on the basis of the position of the toy bullet 121. As a result, as shown in FIG. 11(c) and its side view, FIG. 12(c), if the user fires the toy gun 120 toward the floating image of the target displayed on the image formation surface 21, the “bullet hole” is left on the floating image of the target, simultaneously with or in tandem with that the toy bullet 121 passes through the image formation surface 21. Of course, if the position of the toy bullet 121 passing through the image formation surface 21 is off from the floating image of the target, the floating image of the target is not particularly changed, and there is no “bullet hole” left. As described above, the floating image is significantly changed with respect to the user's operation and the change varies depending on the used tool, i.e. the detected object. Thus, in addition to the interactivity, reality also remarkably increases.

Incidentally, in FIG. 10, if the attribute of the detected object is not detected at all (the step S102: NO), or if the position of the detected object is not detected at all (the step S211: NO), it is not particularly necessary to change the original image. Alternatively, if either the position of the detected object or the attribute is detected, the floating image may be changed in accordance with the detection result.

### (2-3) Other Examples

Next, with reference to FIG. 13 to FIG. 15, an explanation will be given on how to change the floating image if other things other than the toy bullet 121 are used as the detected object.

Firstly, with reference to FIG. 13, an explanation will be given on how to change the floating image if the fork 122 is used as the detected object. FIG. 13 are schematic diagrams showing that the fork is stuck into the floating image, on the image display apparatus in the second embodiment (a: a perspective view, b: a front view showing a change in the floating image). Incidentally, the step numbers shown in FIG. 13(b) correspond to those in the flowchart in FIG. 10.

FIG. 13(a) depicts that a floating image of an apple is displayed on the image formation surface 21 and that the user sticks the fork 122 into the floating image of the apple. FIG. 13(b) shows a series of changes in the floating image at this time. Firstly, as shown in the step S101 in FIG. 13(b), the floating image of the apple is displayed without any cut in the beginning. Then, if the user sticks the fork 122 into the floating image of the apple, the planar area in which the fork 122 crosses the image formation surface 21 is detected by the position detection device 61, and a mask image is generated at the position corresponding to the cross position, as shown in the step S203 in FIG. 13(b). Incidentally, the mask image here is different from the aforementioned “bullet hole” (refer to FIG. 11), and it is a cut in a relatively low damaged condition, based on the attribute of the fork 122 read from the IC tag 52. Lastly, by combining the mask image generated in this manner and the original image, the floating image that the fork 122 is stuck in the apple is obtained, as shown in the step S104 in FIG. 13(b). A mask which is a predetermined margin larger than the crossed planar area as shown in the step S203 in FIG. 13 is preferably generated. As described above, by providing a margin to some degree, it is possible to deal with a case where there are some difference in the view angle between the both eyes of an observer and where the observation is performed at a position off from the front with respect to the formed image to a greater or lesser degree. Incidentally, the mask image corresponding to the attribute of the fork 122 is not necessarily one. A plurality of mask images may be selected by the position of the fork 122 or a change in the position (i.e. movement). For example, if the position of the fork 122 changes only in the depth direction, with the floating image as spaghetti, a mask image in the condition that the spaghetti is “stung” is selected. On the other hand, if the fork 122 rotates with it crossing the image formation surface 21, more various representations can be performed by selecting a mask image in the condition that the spaghetti is “rotated or wound around the fork”.

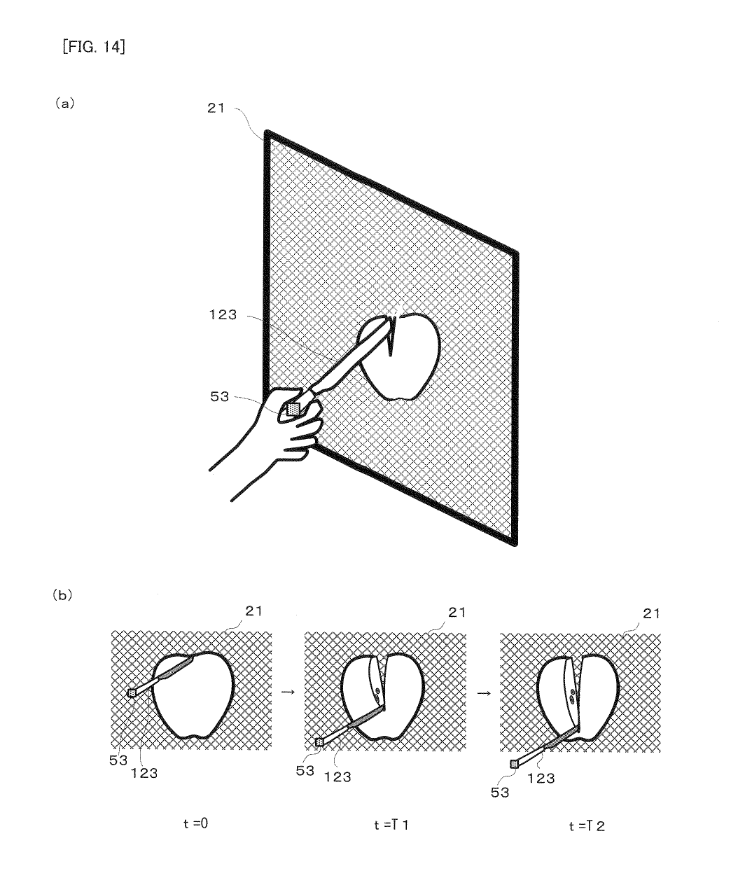

Next, with reference to FIG. 14, an explanation will be given on how to change the floating image if the knife 123 is used as the detected object. FIG. 14 are schematic diagrams showing that the floating image is cut with the knife, on the image display apparatus in the second embodiment (a: a perspective view, b: a front view showing a change in the floating image).

FIG. 14(a) depicts that a floating image of an apple is displayed on the image formation surface 21 and that the user cuts the floating image of the apple with the knife 123. FIG. 14(b) shows a series of changes in the floating image at this time. Firstly, as shown in a time point t=0 in FIG. 14(b), the floating image of the apple is displayed without any cut in the beginning. Then, if the user cuts the floating image of the apple with the knife 123 and time has elapsed, mask images are generated at positions corresponding to a track drawn by the knife 123. Then, the floating images of the apple are obtained as shown in a time point t=T1 and a time point t=T2 in FIG. 14(b). Incidentally, the mask images here are different from the aforementioned “bullet hole” (refer to FIG. 11), and they are relatively sharp cuts based on the attribute of the knife 123 read from the IC tag 53. The reality is further increased by showing the inside of the apple in the cuts. Incidentally, when the knife 123 is displaced as described above, a real-time process may be performed such that the generated mask follows the displacement. Alternatively, the planar area which crosses the image formation surface 21 or a set of the spatial areas may be stored in the memory device 103 as the track, and a mask corresponding to the track may be generated.

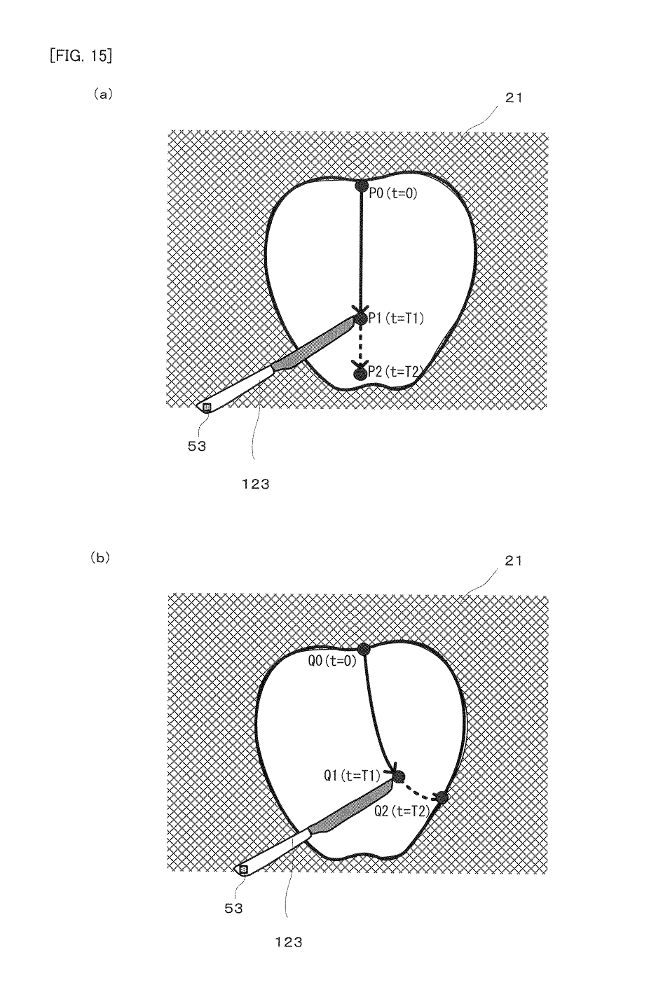

As described above, when the knife 123 is displaced, the generated mask not only follows the current position of the knife 123 but also may predict a destination, as shown in FIG. 15(a) and FIG. 15(b), to make preparation, such as foreseeing the mask image in advance. FIG. 15 are schematic diagrams showing that the movement of the knife is predicted and the floating image is foreseen when the floating image is cut with the knife, on the image display apparatus in the second embodiment (a: a case where it is cut along a route P0-P1, b: a case where it is cut along a route Q0-Q1).

As shown in FIG. 15(a), if the knife 123 is displaced in the lower direction of the screen along a path P0-P1 between the time point t=0 and T1, it is predicted to be displaced in a direction of a point P2, which is directly under the point P1, at a subsequent time point t=T2. Alternatively, as shown in FIG. 15(b), if the knife 123 is displaced in a curve in the lower right direction of the screen along a path Q0-Q1 between the time point t=0 and T1, it is predicted to be displaced in a direction of a point Q2, which is not directly under but on an extended line of the curve, at a subsequent time point t=T2. The prediction can be performed, for example, by recording its track every several hundred milliseconds and by specifying a velocity vector. If the prediction is performed to generate the mask image, a response delay is solved, and the user's sense of discomfort can be reduced, to thereby further improve the interactivity

Incidentally, in the aforementioned embodiment, it is also possible to enjoy such a change that switches one after another depending on the attributes of the fork and the knife which are shifted. Alternatively, it is also possible to enjoy such a new change that the fork and the knife are simultaneously held and the floating image is cut with the knife while the fork is stuck into the floating image.

Moreover, a few other examples in the aforementioned embodiment will be illustrated. For example, in the case of a detected object with an attribute of the lipstick 124 with respect to a floating image of a woman's face, if the lipstick 124 is brought close to and moved on the woman's lips, the floating image is changed to a floating image of putting some lipstick on the lips, or the woman's face is also changed to have a happy facial expression. If the lipstick 124 is brought close to and is moved on the cheek, the woman's face may be changed to have an annoying facial expression, or the woman may also turn her face away. Moreover, it is also possible to enjoy putting on makeup in conjunction with detected objects with attributes such as foundation and eye shadow. Moreover, in the case of a detected object with an attribute of the brush 126, if it is brought closer to and is moved on the image formation surface, it is possible to draw a thick line with its surroundings blurred, like paint. In the case of an attribute of a fountain pen, a thin and sharp line can be drawn. In the case of an attribute of a blue pen, a blue line can be drawn, and in the case of a red pen, a red line can be also drawn.

As described above, according to the embodiment, it is possible to display the stereoscopic two-dimensional image, relatively easily, and it is also possible to improve the rendering effect and interactivity. In particular, in addition to the attribute of the detected object, the position can be also detected, so that not uniform but various reactions can be realized in accordance with the attribute and the position. Thus, the rendering effect as the stereoscopic image becomes enormous.

### (3) Third Embodiment

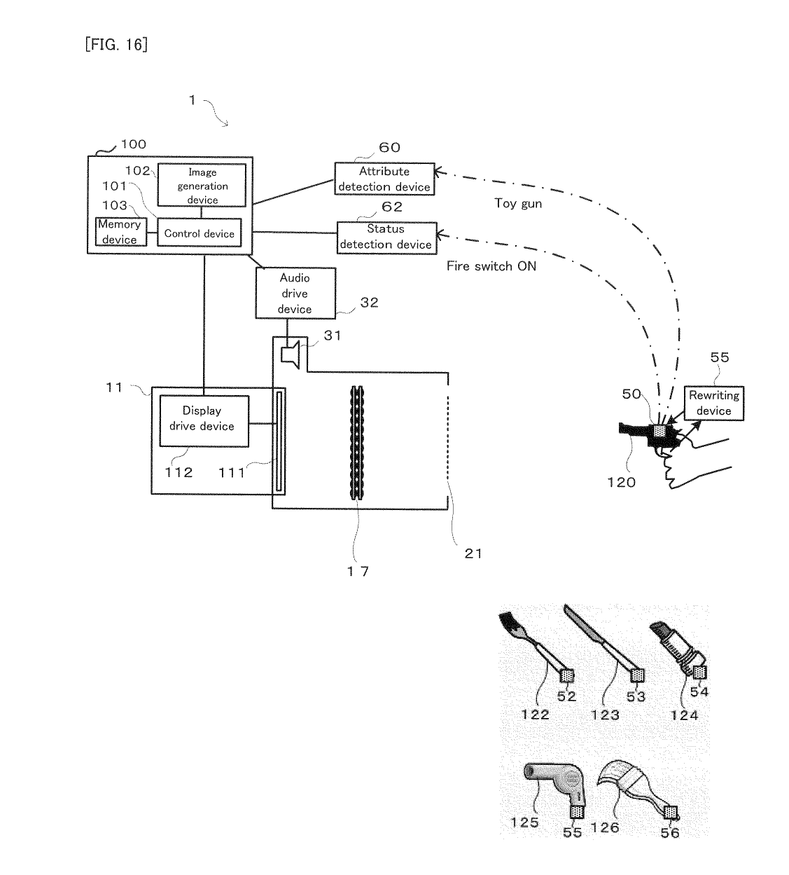

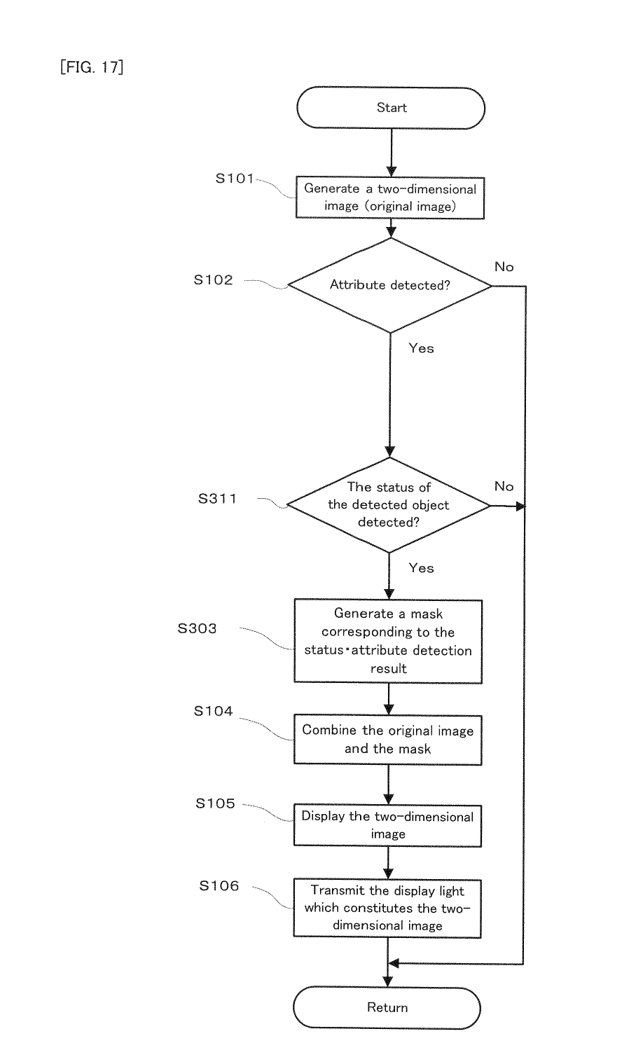

The structure and the operation process of an image display apparatus in a third embodiment will be explained with reference to FIG. 16 and FIG. 17.

### (3-1) Structure

Firstly, the structure of the image display apparatus in the embodiment will be explained with reference to FIG. 16. FIG. 16 is a block diagram conceptually showing the basic structure of the image display apparatus in the third embodiment.

Incidentally, in FIG. 16, the same constituents as those in the aforementioned first embodiment (i.e. FIG. 6) carry the same reference numerals, and their explanation will be omitted as occasion demands.

In FIG. 16, the image display apparatus 1 in the embodiment is further provided with a status detection device 62 and a rewriting device 55, in addition to the constituents of the image display apparatus 1 in the first embodiment described above. Incidentally, the status detection device 62 corresponds to one example of the “status detecting device” of the present invention. The rewriting device 55 corresponds to one example of the “rewriting device” of the present invention.

The status detection device 62 is, for example, an IC tag reader which is the same as the attribute detection device 60, and it detects the status of the detected object by reading the IC tag 50 with the status written in a wireless or wired manner. Incidentally, the “status of the detected object” herein qualitatively or quantitatively indicates some status about the detected object. For example, it indicates a discontinuous two-step status, such as the ON/OFF of a switch, a continuous multistage status, such as low, middle, and high volume, or similar statuses.

The rewriting device 55 is, for example, an IC tag writer, and it can rewrite information recorded in the IC tag 50 by dynamically changing the circuit of the IC tag, for example.

Incidentally, the aforementioned status detection is not necessarily through the IC tag. For example, if the status detection device 62 and the rewriting device 55 can perform transmission and reception by wired communication or wireless communication using electromagnetic waves with a predetermined frequency band, the status detection device 62 can detect the status of the detected object.

### (3-2) Operation

Next, the operation in the embodiment constructed in the above manner will be explained with reference to FIG. 17 in addition to FIG. 16. FIG. 17 is a flowchart showing the basic operation of the image display apparatus in the third embodiment.

In FIG. 17, firstly, the control apparatus 100 enables the image generation device 102 to generate a two-dimensional image (original image) (the step S101). For example, it is assumed, as shown in FIG. 8(a), that the original image is an image of a doll with a target.

Then, it is judged whether or not the attribute of the detected object is detected by the attribute detection device 60 (the step S102). If the attribute of the detected object is detected (the step S102: YES), it is further judged whether or not the status of the detected object is detected by the status detection device 62 (step S311).

If the status of the detected object is detected (the step S311: YES), the following process is performed in accordance with the detected position and the attribute. Incidentally, the case where the status of the detected object and the attribute are detected is as follows: a case where the user fires the toy gun 120, which incorporates the IC tag 50 with the attribute of the detected object written, toward the image formation surface 21 from the detectable range of the status detection device 62 and the attribute detection device 60, and the rewriting device 55 rewrites the status of the IC tag 50 with the status of the detected object written, from “Fire switch ON” to “Fire switch OFF” in accordance with the fire. Alternatively, it is a case where the rewriting device 55 electromagnetically transmits an indication of “Fire switch ON” to the status detection device 62 in accordance with the fire.

Firstly, a mask image is generated that corresponds to the status of the detected toy gun 120 and the attribute by the status detection device 62 and the attribute detection device 60 (step S303). Then, as in the first embodiment, the processes in the steps S104, S105, and S106 are performed, and the floating image is preferably changed in response to the status of the detected toy gun 120 and the attribute. As a result, the user fires the toy gun 120 toward the floating image of the target displayed on the image formation surface 21, and simultaneously with or in tandem with the status of “Fire switch ON”, the “bullet hole” is left on the floating image of the target.

Incidentally, in the step S105, timing to display the two-dimensional image after the combination may be after a predetermined interval, after the status of the detected object is changed. The predetermined interval is obtained, for example, from the position of the toy gun 120 on the fire, or the like, in the aforementioned case.

Moreover, the mask image with respect to the original image (e.g. the position of the bullet hole) may be determined in view of a firing angle in addition to the position of the toy gun 120 on the fire. At this time, the firing angle may be obtained by attaching a plurality of IC tags to a plurality of points on the toy gun 120 (preferably, on a straight line along a firing direction) and by detecting the position of each IC tag. Alternatively, the firing angle may be directly recognized by an imaging element. Moreover, the firing angle and the firing direction may be obtained by providing the toy gun 120 with a six-axis sensor (e.g. acceleration in the XYZ direction, longitudinal inclination, lateral inclination, lateral swing) and by detecting the direction, inclination, and movement of the toy gun 120.

Incidentally, in FIG. 17, if the attribute of the detected object is not detected at all (the step S102: NO), or if the status of the detected object is not detected at all (the step S311: NO), it is not particularly necessary to change the original image. Alternatively, if either the status of the detected object or the attribute is detected, the floating image may be changed in accordance with the detection result.

Moreover, a few other examples in the embodiment will be illustrated. For example, in the case of a detected object with an attribute of the dryer 125 with respect to a floating image of a woman's face, if the status of the dryer 125 is switched OFF, there is no particular change in the floating image. If the status of the dryer 125 is changed to be switched ON, the floating image is changed to a floating image of a woman's face with flowing hair. Moreover, if an intensity switch for an air volume, which is one status of the dryer 125, is changed, the hair flowing degree may be changed. Moreover, by detecting the direction, angle, position, and movement of the dryer 125, the position and status of the flowing hair may be also changed partially. Moreover, there may be a change that the wet hair is dried with time.

As described above, according to the embodiment, the floating image is significantly changed with respect to the user's operation, and the change varies depending on the used tool, i.e. the detected object. Thus, in addition to the interactivity, reality also remarkably increases. At this time, the change can be made in accordance with the user's operation even without detecting a strict position, and the interactivity is improved.

Incidentally, in the aforementioned embodiments, the attribute, position, status, and the like of the detected object may be detected by arbitrarily combining the aforementioned various methods, procedures, and means. In this manner, in accordance with the specification of the image display apparatus, it is possible to detect the necessary information, appropriately or accurately. For example, all the information such as the attribute, the position, and the status may be exchanged at a time by wireless communication with the detected object which incorporates a memory and a six-axis sensor.

Incidentally, the present invention is not limited to the aforementioned embodiments, but may be changed, if necessary, without departing from the scope or idea of the invention, which can be read from all the claims and the specification thereof. The image display apparatus with such a change is also included in the technical scope of the present invention.

### INDUSTRIAL APPLICABILITY

The image display apparatus of the present invention can be applied to an image display apparatus for stereoscopically displaying the two-dimensional image on the basis of the 3D floating vision method, for example.

1-10. (canceled)

11. An image display apparatus comprising:
a displaying device for displaying an image on a screen;
an image transmitting device which is disposed on an optical path of display light which constitutes the image and which transmits the display light which constitutes the image so as to display a real image of the image as a floating image on an image formation surface located in a space on an opposite side to the screen;
an attribute specifying device for specifying an attribute of a detected object located in a real space portion including the space; and a controlling device for controlling said displaying device to change the floating image into a form which is associated with the specified attribute of the detected object in advance, wherein said attribute specifying device has an attribute detecting device for detecting the attribute, said image display apparatus further comprises a tag device which is attached to the detected object and in which attribute information indicating the attribute of the detected object is recorded readably in an electromagnetic-optic manner, and
said attribute detecting device detects the attribute by reading the recorded attribute information in an electromagnetic-optic manner.

12. An image display apparatus comprising:
a displaying device for displaying an image on a screen;
an image transmitting device which is disposed on an optical path of display light which constitutes the image and which transmits the display light which constitutes the image so as to display a real image of the image as a floating image on an image formation surface located in a space on an opposite side to the screen;
an attribute specifying device for specifying an attribute of a detected object located in a real space portion including the space; and a controlling device for controlling said displaying device to change the floating image into a form which is associated with the specified attribute of the detected object in advance, wherein said image display apparatus further comprises a position detecting device for detecting where the position of the detected object is in the real space portion, said controlling device controls said displaying device to change the floating image into a form which is also associated with the detected position of the detected object in advance, in addition to the specified attribute, said image display apparatus further comprises a memory device for storing a track of the position of the detected object changed, if the detected position of the detected object changes with time, said controlling device controls said displaying device to change the floating image into a form which is also associated with the stored track of the position of the detected object in advance, in addition to the specified attribute, said image display apparatus further comprises a predicting device for predicting where the position of the detected object is changed to in the real space portion, on the basis of the stored track of the position of the detected object, and said controlling device controls said displaying device to foresee the image in a form which is also associated with the predicted position of the detected object in advance, in addition to the specified attribute.

13. The image display apparatus according to claim 11, wherein said image display apparatus further comprises a status detecting device for detecting a status of the detected object, and said controlling device controls said displaying device to change the floating image into a form which is also associated at least with the detected status of the detected object in advance, in addition to the specified attribute.

14. The image display apparatus according to claim 12, wherein said image display apparatus further comprises a tag device which is attached to the detected object and in which attribute information indicating the attribute of the detected object is recorded readably in an electromagnetic-optic manner, and said position detecting device detects the position of the detected object by detecting where a position of said tag device attached to the detected object is in the real space portion.

15. The image display apparatus according to claim 11, wherein in addition to the attribute information, status information indicating a status of the detected object is recorded readably in an electromagnetic-optic manner in said tag device, and said image display apparatus further comprises a rewriting device for rewriting at least the status information.

16. The image display apparatus according to claim 11, wherein said image transmitting device comprises a microlens array, and the floating image is displayed as a real image of the image.

17. The image display apparatus according to claim 11, wherein the attribute is uniquely associated with the detected object, and the attribute indicates at least a shape of the detected object.

18. The image display apparatus according to claim 12, wherein said image display apparatus further comprises a status detecting device for detecting a status of the detected object, and said controlling device controls said displaying device to change the floating image into a form which is also associated at least with the detected status of the detected object in advance, in addition to the specified attribute.

19. The image display apparatus according to claim 12, wherein said image transmitting device comprises a microlens array, and the floating image is displayed as a real image of the image.

20. The image display apparatus according to claim 12, wherein the attribute is uniquely associated with the detected object, and the attribute indicates at least a shape of the detected object.
